(19) United States
(12) Patent Application Publication
(10) Pub. No.: US 2024/0239205 A1
(43) Pub. Date: Jul. 18, 2024

(54) AXLE TORQUE ESTIMATION IN ELECTRIC VEHICLES WITH MULTI-SPEED DRIVE UNIT

(71) Applicant: GM Global Technology Operations LLC, Detroit, MI (US)

(72) Inventors: Paul Guillermo Otanez, Franklin, MI (US); Chunhao J. Lee, Troy, MI (US); Dongxu Li, Troy, MI (US); Su-Yang Shieh, Clawson, MI (US)

(21) Appl. No.: 18/153,531

(22) Filed: Jan. 12, 2023

(51) Int. Cl. B60L 15/20; B60L 3/00

(52) U.S. Cl. CPC B60L 15/20; B60L 3/0061; B60L 2240/14; B60L 2240/423; B60L 2260/28; B60L 2260/44

(57) ABSTRACT

An electric vehicle, a system and a method of operating the electric vehicle. The system includes a first motor, a drive unit between the first motor and a first axle of the electric vehicle, a second motor, and a processor. The processor is configured to receive a request for the electric vehicle, receive a torque signal from the drive unit, determine at least one of a first motor torque for the first motor and a second motor torque for the second motor based on the torque signal and the request, and apply the at least one of the first motor torque at the first motor and the second motor torque at the second motor to satisfy the request.

### INTRODUCTION

The subject disclosure relates to electric vehicles and, more specifically, to a system and method for operating a multi-speed drive unit of a transmission of an electric vehicle to achieve a desired response.

Electric vehicles have been designed to include an electric motor on each axle. A transmission for an axle controls a gear ratio between the associated electric motor and the axle. It is desired to maintain a smooth ride during a gear shift, such as by maintaining a constant acceleration of the electric vehicle. This goal is complicated by having electric motors on multiple axles. Accordingly, it is desirable to coordinate the operation of electric motors on different axles in order to ensure a smooth gear shift operation.

### SUMMARY

In one exemplary embodiment, a method of operating an electric vehicle is disclosed. A request is received at a controller of the electric vehicle. The controller receives a torque signal from a drive unit at a first axle of the electric vehicle. At least one of a first motor torque at the first axle and a second motor torque at a second axle of the electric vehicle is determined based on the torque signal and the request. At least one of the first motor torque is applied at the first axle and the second motor torque is applied at the second axle to satisfy the request.

In addition to one or more of the features described herein, the method further includes applying the at least one of the first motor torque and the second motor torque to maintain an acceleration profile of the electric vehicle during a gear shift operation. The controller is one of a vehicle controller in communication with a first motor of the first axle and a second motor of the second axle and a processing circuit of the first motor that determines only the first motor torque and applies the first motor torque at the first axle. The torque signal is indicative one of a current output torque of the drive unit and a predicted output torque of the drive unit. The method further includes determining the at least one of the first motor torque and the second motor torque based on at least one of a difference between the torque signal and a torque sensed at the first axle and a difference between a torque at the first axle and a torque at the second axle. The request is at least one of a speed of the electric vehicle, an acceleration of the electric vehicle, and a torque at the electric vehicle. The method further includes generating a torque delivery fault when at least one of a difference between a requested input torque to the drive unit to an estimated input torque to the drive unit exceeds a calibratable limit and the difference between a requested output torque of the drive unit and an estimated output torque of the drive unit exceeds the calibratable limit.

In another exemplary embodiment, a system for operating an electric vehicle is disclosed. The system includes a first motor, a drive unit between the first motor and a first axle of the electric vehicle, a second motor, and a processor. The processor is configured to receive a request for the electric vehicle, receive a torque signal from the drive unit, determine at least one of a first motor torque for the first motor and a second motor torque for the second motor based on the torque signal and the request, and apply the at least one of the first motor torque at the first motor and the second motor torque at the second motor to satisfy the request.

In addition to one or more of the features described herein, the processor is further configured to apply the at least one of the first motor torque and the second motor torque to maintain an acceleration profile of the electric vehicle during a gear shift operation. The processor is one of a vehicle controller in communication with the first motor and the second motor and a processing circuit of the first motor that determines only the first motor torque and applies the first motor torque at the first axle. The torque signal is one of a current output torque of the drive unit and a predicted output torque of the drive unit. The processor is further configured to determine the at least one of the first motor torque and the second motor torque based on at least one of a difference between the torque signal and a torque sensed at the first axle and a difference between a torque at the first axle and a torque at the second axle. The request is at least one of a speed of the electric vehicle, an acceleration of the electric vehicle, and a torque at the electric vehicle. The processor is further configured to generate a torque delivery fault when at least one of a difference between a requested input torque to the drive unit to an estimated input torque to the drive unit exceeds a calibratable limit and the difference between a requested output torque of the drive unit and an estimated output torque of the drive unit exceeds the calibratable limit.

In yet another exemplary embodiment, an electric vehicle is disclosed. The electric vehicle includes a first motor, a drive unit between the first motor and a first axle of the electric vehicle, a second motor, and a processor. The processor is configured to receive a request for the electric vehicle, receive a torque signal from the drive unit, determine at least one of a first motor torque for the first motor and a second motor torque for the second motor based on the torque signal and the request, and apply the at least one of the first motor torque at the first motor and the second motor torque at the second motor to satisfy the request.

In addition to one or more of the features described herein. The processor is further configured to apply the at least one of the first motor torque and the second motor torque to maintain an acceleration profile of the electric vehicle during a gear shift operation. The processor is one of a vehicle controller in communication with the first motor and the second motor and a processing circuit of the first motor that determines only the first motor torque and applies the first motor torque at the first axle. The torque signal is one of a current output torque of the drive unit and a predicted output torque of the drive unit. The processor is further configured to determine the at least one of the first motor torque and the second motor torque based on at least one of a difference between the torque signal and a torque sensed at the first axle and a difference between a torque at the first axle and a torque at the second axle. The request is at least one of a speed of the electric vehicle, an acceleration of the electric vehicle, and a torque at the electric vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a schematic diagram of an electric vehicle in a plan view, in accordance with an exemplary embodiment;

FIG. 2 illustrates a block diagram of a control system for operating the electric vehicle of FIG. 1;

FIG. 3 shows a block diagram detailing the components of a drive system of a first axle of the electric vehicle;

FIG. 4 shows a schematic diagram of the first drive unit, in an illustrative embodiment;

FIG. 5 illustrates a local control operation for the control system;

FIG. 6 shows use of a predicted output torque of a drive unit to control operation of the control system;

FIG. 7 shows an illustrative predicted torque that can be sent from the first drive unit to the vehicle controller;

FIG. 8 shows first torque allocation based on the predicted torque of FIG. 7;

FIG. 9 shows second torque allocation based on the predicted torque of FIG. 7;

FIG. 10 shows an acceleration profile for the gear shift operation using the predicted torque; and

FIG. 11 shows a block diagram of a control system for operating the electric vehicle, in an alternate embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

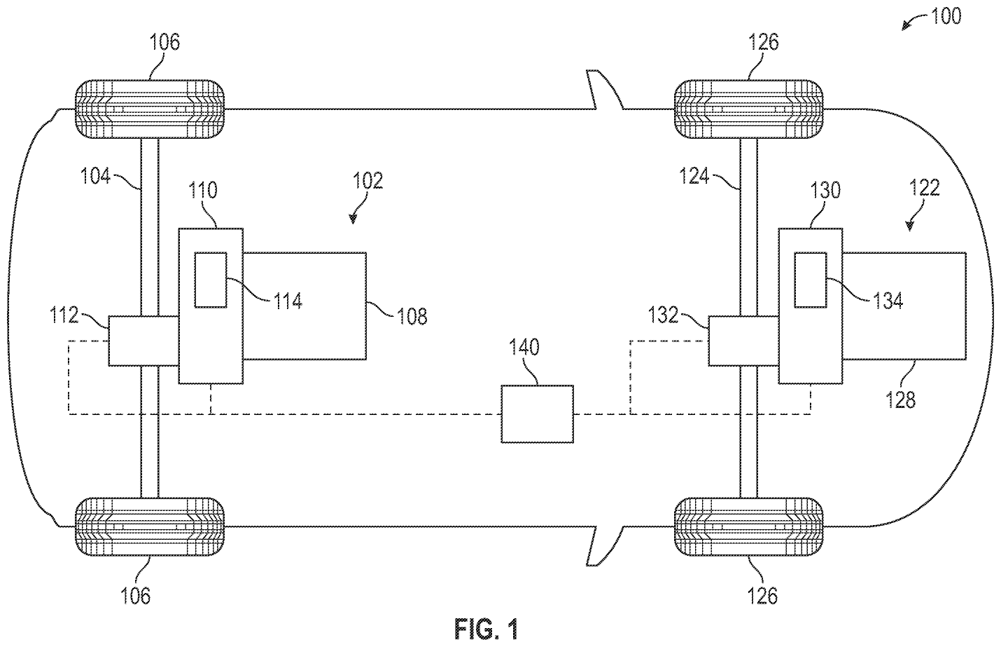

In accordance with an exemplary embodiment, FIG. 1 shows a schematic diagram of an electric vehicle 100 in a plan view. The electric vehicle includes a first drive system 102 and a second drive system 122. For illustrative purposes the first drive system 102 is a rear drive system and the second drive system 122 is a front drive system. The first drive system 102 provides power to a first axle 104 that is connected to first wheels 106. The second drive system 122 provides power to a second axle 124 that is connected to a second wheels 126.

The first drive system 102 includes a first battery 108, a first motor 110, and a first transmission or first drive unit 112. The first motor 110 is an electric motor that converts power from the first battery 108 into kinetic energy in the form of a rotation. The first drive unit 112 can engage the first motor 110 to transfer the rotation from the first motor to the first axle 104 and first wheels 106. The first motor 110 can include a first regenerative braking system 114. During braking, the first regenerative braking system 114 converts rotational energy of the first axle 104 into electrical energy or current which is used to recharge the first battery 108.

Similarly, the second drive system 122 includes a second battery 128, a second motor 130, and a second transmission or second drive unit 132. The second motor 130 is an electric motor that converts power from the second battery 128 into kinetic energy in the form of a rotation. The second drive unit 132 can engage the second motor 130 to transfer the rotation to the second axle 124 and second wheels 126. The second motor 130 can include a second regenerative braking system 134. During braking, the second regenerative braking system 134 converts rotational energy of the second axle 124 into electrical energy or current which is used to recharge the second battery 128. In an embodiment, the second drive system 122 can be engaged when the vehicle is placed in an all-wheel drive mode and can be disengaged or shut down when not in the all-wheel drive mode.

While the electric vehicle 100 of FIG. 1 shows two drive systems, it is understood that there can be additional drive systems for different embodiments of the vehicle. In various applications, the first axle 104 can have multiple associated drive systems and/or the second axle 124 can have multiple associated drive systems. In some embodiments, only the first axle 104 can have a drive unit or only the second axle 124 can have a drive unit. In an embodiment, in which a single motor is used on an axle, a differential can be used to transfer torque from the single motor to two wheels. When two motors are used on an axle, each motor can be dedicated to a wheel and thus the differential is not needed. Additionally, it is understood that the first battery 108 and the second battery 128 can be replaced by a single battery that powers both the first motor 110 and the second motor 130.

A vehicle controller 140 is in communication with the first drive system 102, including the first motor 110 and the first drive unit 112, and the second drive system 122, including the second motor 130 and the second drive unit 132. The vehicle controller 140 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The vehicle controller 140 may include a non-transitory computer-readable medium that stores instructions which, when processed by one or more processors of the vehicle controller 140, implement a method of controlling shifting of gears of at least one of the first drive unit 112 and the second drive unit 132, according to one or more embodiments detailed herein.

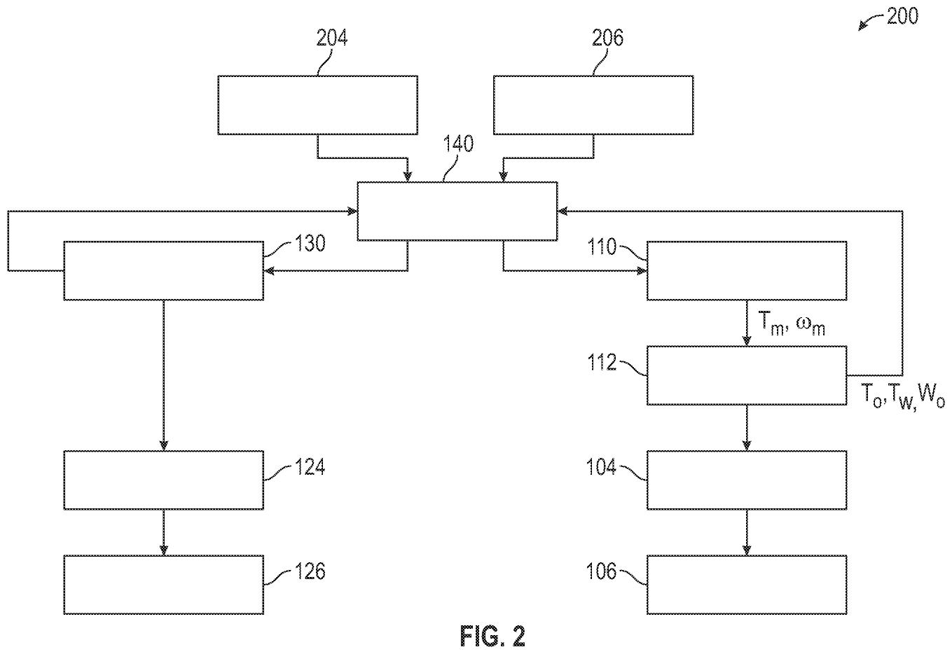

FIG. 2 illustrates a block diagram of a control system 200 for operating the electric vehicle 100. The control system 200 includes the vehicle controller 140 which is in communication with the first motor 110 and the second motor 130. First drive unit 112 connects the first motor 110 to a first axle 104 and transfers torque from the first motor 110 to the first axle and first wheels 106. The first motor 110 outputs a first motor torque Tₘ and a first motor speed ωₘ, which are transmitted to the first drive unit 112. The first drive unit 112 outputs a torque signal that can include an output torque Tₒ (or current output torque) and a drive unit output speed ω₀ (or current output speed). The torque signal is transmitted to the first axle 104. The first drive unit 112 includes gears and at least one clutch to allow shifting of gears (i.e., changing gear ratios between an input torque (e.g., Tₘ) and an output torque (e.g., Tₒ)). Various sensors can be used to measure torques and speeds.

In various embodiments, the first motor 110 includes a processing circuit that controls operation of the first motor. For illustrative purposes, the second drive unit 132 is not shown. Second motor 130 is connected directly to the second axle 124 and transmits its torque to the second axle and second wheels 126. The second motor 130 includes a processing circuit that controls operation of the second motor. The processing circuit of the second motor 130 communicates signals, such as the second motor torque and/or the second motor speed to the vehicle controller 140. In addition, the first drive unit 112 includes a processing circuit that can control operation of the drive unit and communicate an electric signal to the vehicle controller 140 indicating, for example, a current drive output torque Tₒ, a current wheel torque T_{w}, a current drive output velocity ωₒ, etc.

To operate the control system 200, the vehicle controller 140 receives a request with respect to vehicular motion or vehicular dynamics. The request can be a speed request, an acceleration request, a torque request, or any combination thereof. The request can be either a human request from a human machine interface 204 or an autonomous request from the electric vehicle 100. The human machine interface 204 can be, for example, a gas pedal, brake pedal, etc. through which driver enters the request. The vehicle controller 140 satisfies the request by determining a torque at the vehicle that meets or satisfies the request, determining an allocation of torques among the first motor 110 and the second motor 130, and sending appropriate signals to one or both of the first motor 110 and the second motor 130. The vehicle controller 140 can determine torque allocation based on the request and feedback from the first drive unit 112 and the second motor 130. In various embodiments, the torque is allocated to maintain a desired acceleration profile at the electric vehicle 100, such as a constant acceleration, an increase in acceleration, a decrease in acceleration, etc.

The vehicle controller 140 can compare a requested input torque at the drive unit to an estimated input torque and generate a torque delivery fault if the difference between the requested input torque and the estimated input torque exceeds a calibratable limit. Similarly, the vehicle controller 140 can compare a requested output torque at the drive unit to an estimated output torque and generate a torque delivery fault if the difference between the requested output torque and the estimated output torque exceeds a calibratable limit. Additionally, the vehicle controller 140 can determine first motor torque and second motor torque based on a difference between a first torque at the first axle and a second torque at the second axle.

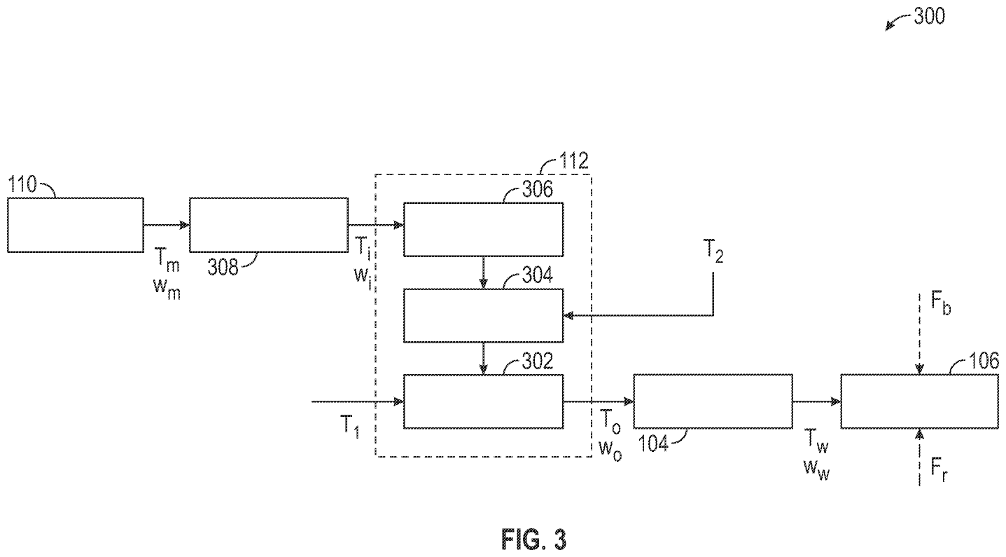

FIG. 3 shows a block diagram 300 detailing the components of the first axle's drive system. The drive system includes the first motor 110, the first drive unit 112, the first axle 104 and first wheels 106. The first drive unit 112 includes a sun gear 302, a carrier gear 304 and a ring gear 306, which are used to change gear ratios (i.e., a ratio between an input torque at the first drive unit 112 and an output torque from the first drive unit 112). The first motor 110 is mechanically coupled to the ring gear 306 of the first drive unit 112 by an input shaft 308 or motor shaft.

Torque losses and speed losses occur at the input shaft 308 during operation. An equation of motion for the input shaft is shown as indicated in Eq. (1):

$$\ddot{x} = - kx - b \dot{x} + {T}_{m} + {T}_{i} + {η}_{1} \qquad Eq . ( 1 )$$

where x is an angle of rotation of the input shaft, \dot{x} is an angular velocity of the input shaft and \ddot{x} is an angular acceleration of the input shaft. Tₘ is a motor torque applied to the input shaft 308. Tᵢ is a torque applied to the input shaft 308 by the first drive unit 112. The parameter η₁ represents unmodelled dynamics, such as friction loss or other torque based on speed, temperature, etc.

The input shaft torque Ti and input shaft speed ωᵢ are input to the first drive unit 112. The input shaft torque is received at the ring gear 306 and transmitted to the carrier gear 304 and from there to the sun gear 302. A clutch at the sun gear 302 controls an output torque Tₒ and output speed ωₒ by the first drive unit 112.

The first clutch torque T₁ is dependent on a clutch pressure P₁ and a clutch slip speed ω₁, as shown in Eq. (2):

$${T}_{1} = f ( {P}_{1} ) tanh ( {ω}_{1} / {c}_{1} ) \qquad Eq . ( 2 )$$

The first axle 104 connects the first drive unit 112 to the first wheels 106 and transfers the output torque to the wheel. The clutch torque can be represented by a continuous function (such as the tanh function) to help in performing calculations in real-time.

The first drive unit 112 provides its output torque Tₒ and output speed ωₒ to the first axle 104. Torque losses and speed losses occur at the first axle 104, as indicated in Eq. (3):

$$\ddot{y} = - ky - b \dot{y} + {T}_{0} + {T}_{w} + {η}_{2} \qquad Eq . ( 3 )$$

where y is an angle of rotation of the axle, \dot{y} is an angular velocity of the axle and ÿ is an angular acceleration of the input shaft. Tₒ is the output torque of the first drive unit 112 and T_{w} is a torque applied to the axle by the first wheels 106. The wheel torque T_{w} can result from a brake force F_{b} and/or a road force Fᵣ. The parameter η₂ represented unmodelled dynamics, such as friction loss or other torque based on speed, temperature, etc.

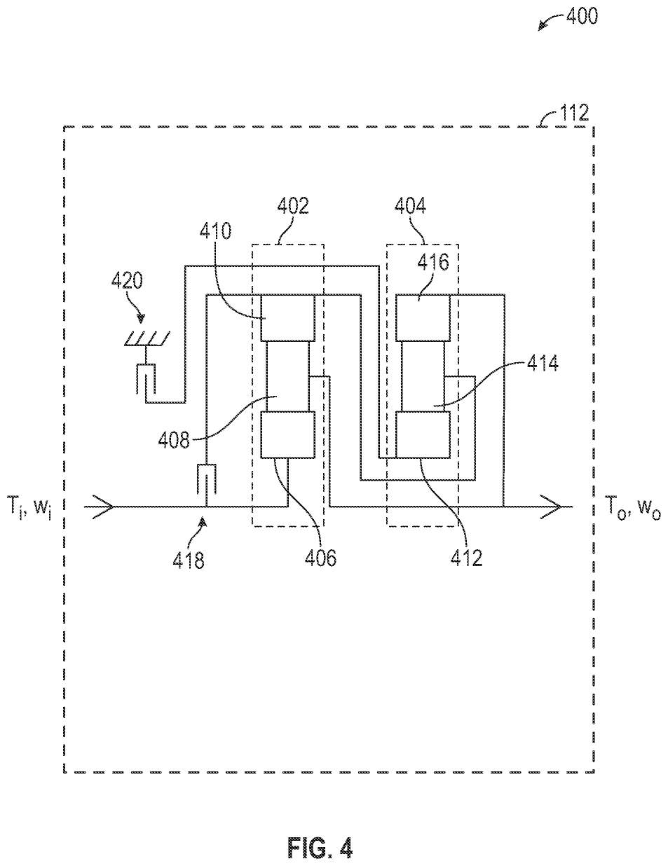

FIG. 4 shows a schematic diagram 400 of the first drive unit 112, in an illustrative embodiment. The first drive unit 112 includes a first planetary gearset 402 and a second planetary gearset 404. The first planetary gearset 402 includes a first sun gear 406, a first carrier gear 408 and a first ring gear 410. The second planetary gearset 404 includes a second sun gear 412, a second carrier gear 414 and a second ring gear 416. The first ring gear 410 is coupled to the second carrier gear 414. A first clutch 418 controls torque transfer at the first planetary gearset 402. A second clutch 420 controls torque transfer at the second planetary gearset 404. The input torque Tᵢ is received either at the first sun gear 406 or the first ring gear 410. The output torque Tₒ is taken from either the first carrier gear 408 or the second ring gear 416.

The vehicle controller 140 receives requests, determines a desired motion for the vehicle from the requests, determines various torques for meeting the desired motion, and determines an allocation of the torques among the motors. The vehicle controller 140 can make these calculations for a gear shift operation.

In one embodiment, the vehicle controller 140 receives commanded signals such as the motor torque Tₘ, wheel torque T_{w}, first clutch pressure P₁ and second clutch pressure P2, as well as measured values of current motor angular velocity ωₘ, current output angular velocity ω₀ and current wheel angular velocity ωₘ. The vehicle controller 140 calculates output torque Tₒ, motor angular velocity ωₘ, output angular velocity ω₀ and wheel angular velocity ω_{w} to be applied to the drive system from these inputs.

In another embodiment, motor torque Tₘ and wheel torque T_{w} are commanded signals provided to the vehicle controller 140. Measurements are made of the first clutch pressure P1 and the second clutch pressure P2, motor angular velocity ωₘ, output angular velocity ω₀ and wheel angular velocity ω_{w}. These measurements are provided as input to the vehicle controller 140. The vehicle controller 140 outputs an output torque Tₒ, motor angular velocity ωₘ, output angular velocity ω₀ and wheel angular velocity ω_{w}, first clutch pressure P1 and second clutch pressure P2 to be applied to the drive system.

Returning to FIG. 2, the vehicle controller 140 performs a global control operation of the drive system. In other words, the vehicle controller 140 sends commands to both the first motor 110 and the second motor 130.

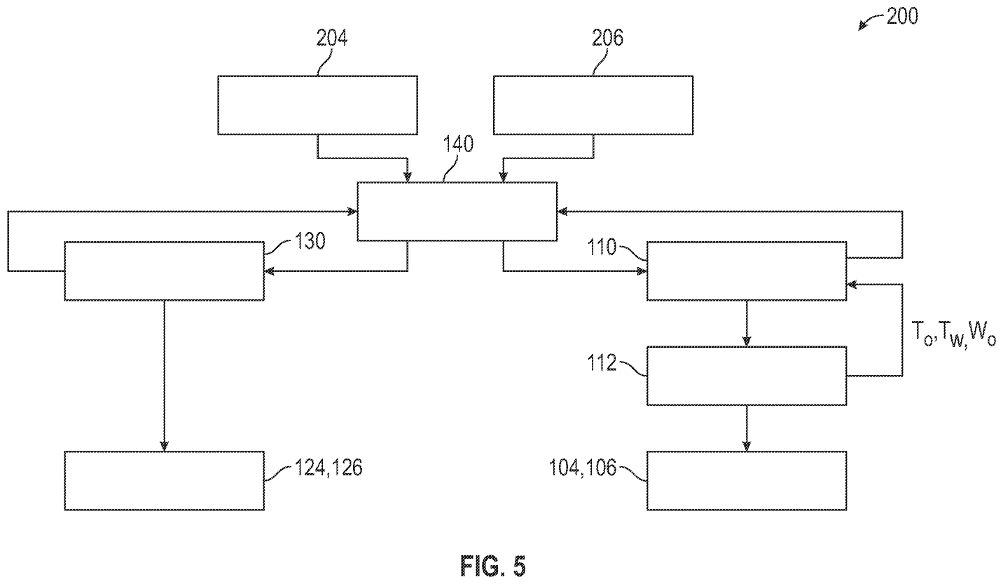

FIG. 5 illustrates a local control operation for the control system 200. A torque signal is sent from the first drive unit 112 to the first motor 110. The torque signal can include one or more of a current drive output torque Tₒ, a current wheel torque T_{w}, a current drive output velocity ωₒ, etc. Based on this signal, the processing circuit of the first motor 110 can compute a motor torque needed at the first motor to provide the allocated torque requirement sent from the vehicle controller 140. The vehicle controller 140 can further provide a torque at the second axles to the first driver unit 112 and the first drive unit 112 can determine the motor torque needed at the first motor using the torque at the second axle. The processing circuit of the first motor 110 can also use P1, P2, ωₘ, and ω_{w} in its calculations of motor torque. The processing circuit can then operate the first motor 110 to achieve this output torque. It is noted that the processing circuit can determine the motor torque for the first axle based on both the first motor torque and the second motor torque.

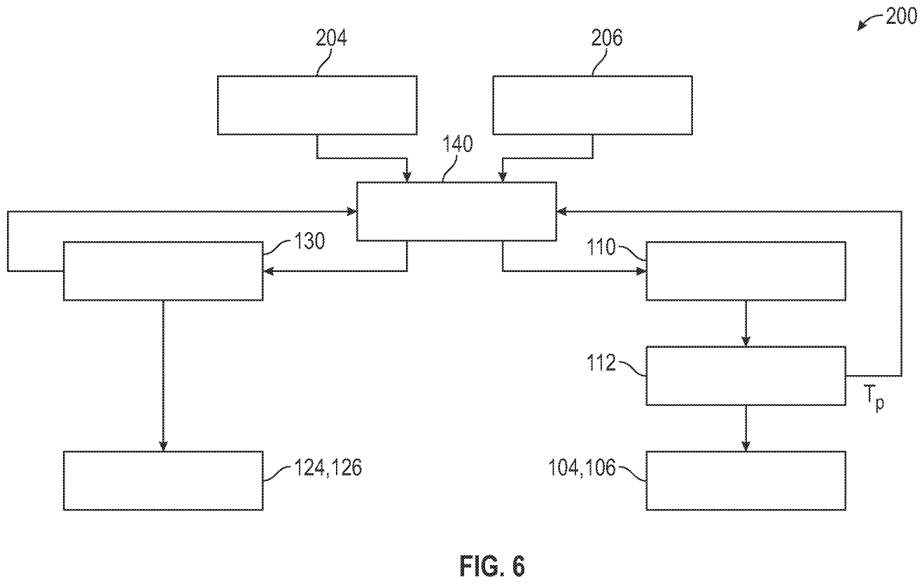

FIG. 6 shows use of a predicted output torque of a drive unit to control operation of the control system 200. The signal from the first drive unit 112 is not a current torque, as in FIG. 2, but a predicted torque Tₚ.

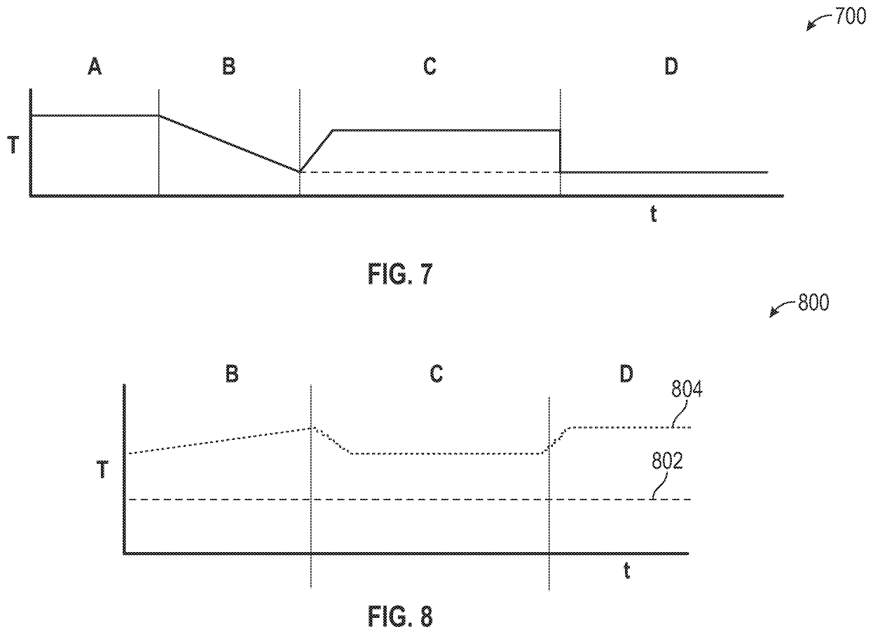

FIG. 7 shows an illustrative predicted torque 700 that can be sent from the first drive unit 112 to the vehicle controller 140. Time (t) is shown along the abscissa and torque (T) is shown along the ordinate axis. The predicted torque changes its value during various phases of the gear shift operation. In a first phase A, the torque is a constant positive value. In a second phase B, the torque is linearly decreasing. In a third phase C, the torque steps to a second constant positive value. In a fourth phase D, the torque can be a positive or negative value. With the predicted torque, the vehicle controller 140 has future knowledge of what the drive unit is going to do, can therefore foresee any future compensation needs for the drive unit and can control the other axles to provide such compensation.

FIG. 8 shows first torque allocation 800 based on the predicted torque of FIG. 7. Time (t) is shown along the abscissa and torque (T) is shown along the ordinate axis. The second phase B, third phase C and fourth phase D are shown. Line 802 shows a first motor torque for the first motor 110, which remains constant throughout the gear shift operation. The second motor torque for the second motor 130 is shown in line 804. The second motor torque changes during each phase. During the second phase B, the second motor torque is linearly increasing. During the third phase C, the second motor torque steps to a lower constant value. During the fourth phase, the second motor torque steps to a higher constant value.

FIG. 9 shows second torque allocation 900 based on the predicted torque of FIG. 7. Time (t) is shown along the abscissa and torque (T) is shown along the ordinate axis. The second phase B, third phase C and fourth phase D are shown. Line 902 shows a first motor torque for the first motor 110. Line 904 shows a second motor torque for the second motor. As can be seen by a comparison of FIGS. 8 and 9, the torques for the first motor are the second motor are reversed for the second torque allocation.

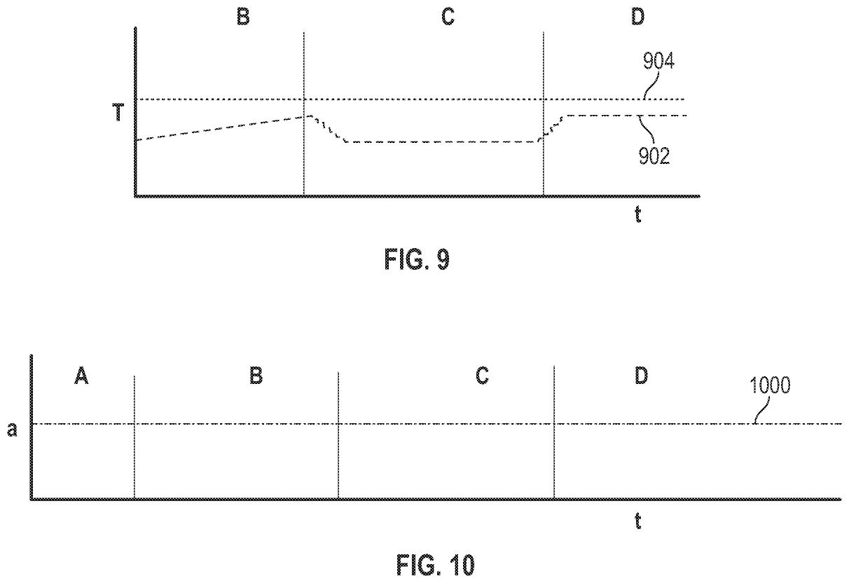

FIG. 10 shows an acceleration profile 1000 for the gear shift operation using the predicted torque. Time (t) is shown along the abscissa and acceleration (a) is shown along the ordinate axis. Although the acceleration profile 1000 is shown as a constant acceleration for all phases of the gear shift operation, other profiles can be used. For example, an acceleration provide can include a slight increase or decrease in acceleration during a selected phase or phases of the gear shift operation.

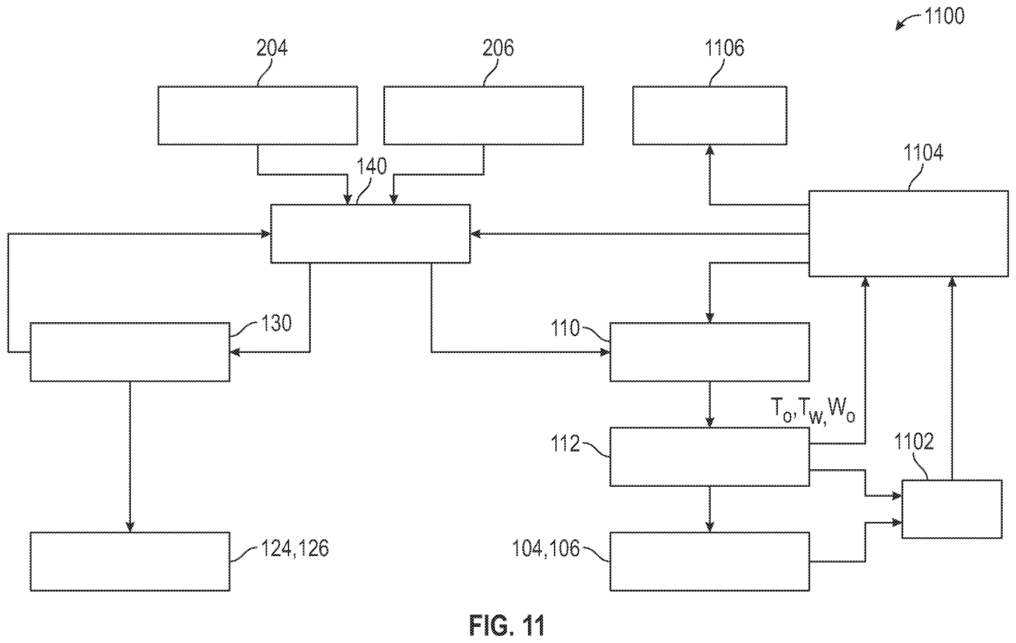

FIG. 11 shows a block diagram 1100 of a control system 200 for operating the electric vehicle 100, in an alternate embodiment. The control system 200 includes a virtual torque sensor (VTS 1102) that measures torque. The VTS 1102 measures an axle torque and sends the axle torque to a model mismatch module 1104. The model mismatch module 1104 can be a processing circuit or a software program operating at a processor, such as at the vehicle controller 140. The first drive unit 112 also sends a signal to the model mismatch module 1104 indicating its output torque Tₒ. The model mismatch module 1104 determines a difference between the drive unit's output torque Tₒ and the axle torque. The difference can be sent to the vehicle controller 140, which alters its torque allocation calculations based on the difference. Alternatively, the difference can be sent to the first motor which alters its motor torque based on calculations. The difference can also be sent to other computing locations 1106 in the electrical vehicle.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating an electric vehicle, comprising:
receiving a request at a controller of the electric vehicle;
receiving, at the controller, a torque signal from a drive unit at a first axle of the electric vehicle;
determining at least one of a first motor torque at the first axle and a second motor torque at a second axle of the electric vehicle based on the torque signal and the request; and
applying the at least one of the first motor torque at the first axle and the second motor torque at the second axle to satisfy the request.

2. The method of claim 1, further comprising applying the at least one of the first motor torque and the second motor torque to maintain an acceleration profile of the electric vehicle during a gear shift operation.

3. The method of claim 1, wherein the controller is one of: (i) a vehicle controller in communication with a first motor of the first axle and a second motor of the second axle; and (ii) a processing circuit of the first motor that determines only the first motor torque and applies the first motor torque at the first axle.

4. The method of claim 1, wherein the torque signal is indicative one of a current output torque of the drive unit and a predicted output torque of the drive unit.

5. The method of claim 1, further comprising determining the at least one of the first motor torque and the second motor torque based on at least one of: (i) a difference between the torque signal and a torque sensed at the first axle; and (ii) a difference between a torque at the first axle and a torque at the second axle.

6. The method of claim 1, wherein the request is at least one of: (i) a speed of the electric vehicle; (ii) an acceleration of the electric vehicle; and (iii) a torque at the electric vehicle.

7. The method of claim 1, further comprising generating a torque delivery fault when at least one of: (i) a difference between a requested input torque to the drive unit to an estimated input torque to the drive unit exceeds a calibratable limit; and (ii) the difference between a requested output torque of the drive unit and an estimated output torque of the drive unit exceeds the calibratable limit.

8. A system for operating an electric vehicle, comprising:
a first motor;
a drive unit between the first motor and a first axle of the electric vehicle;
a second motor; and
a processor configured to:
receive a request for the electric vehicle;
receive a torque signal from the drive unit;
determine at least one of a first motor torque for the first motor and a second motor torque for the second motor based on the torque signal and the request; and
apply the at least one of the first motor torque at the first motor and the second motor torque at the second motor to satisfy the request.

9. The system of claim 8, wherein the processor is further configured to apply the at least one of the first motor torque and the second motor torque to maintain an acceleration profile of the electric vehicle during a gear shift operation.

10. The system of claim 8, wherein the processor is one of: (i) a vehicle controller in communication with the first motor and the second motor; and (ii) a processing circuit of the first motor that determines only the first motor torque and applies the first motor torque at the first axle.

11. The system of claim 8, wherein the torque signal is one of a current output torque of the drive unit and a predicted output torque of the drive unit.

12. The system of claim 8, wherein the processor is further configured to determine the at least one of the first motor torque and the second motor torque based on at least one of: (i) a difference between the torque signal and a torque sensed at the first axle; and (ii) a difference between a torque at the first axle and a torque at the second axle.

13. The system of claim 8, wherein the request is at least one of: (i) a speed of the electric vehicle; (ii) an acceleration of the electric vehicle; and (iii) a torque at the electric vehicle.

14. The system of claim 8, wherein the processor is further configured to generate a torque delivery fault when at least one of: (i) a difference between a requested input torque to the drive unit to an estimated input torque to the drive unit exceeds a calibratable limit; and (ii) the difference between a requested output torque of the drive unit and an estimated output torque of the drive unit exceeds the calibratable limit.

15. An electric vehicle, comprising:
a first motor;
a drive unit between the first motor and a first axle of the electric vehicle;
a second motor; and
a processor configured to:
receive a request for the electric vehicle;
receive a torque signal from the drive unit;
determine at least one of a first motor torque for the first motor and a second motor torque for the second motor based on the torque signal and the request; and
apply the at least one of the first motor torque at the first motor and the second motor torque at the second motor to satisfy the request.

16. The electric vehicle of claim 15, wherein the processor is further configured to apply the at least one of the first motor torque and the second motor torque to maintain an acceleration profile of the electric vehicle during a gear shift operation.

17. The electric vehicle of claim 15, wherein the processor is one of: (i) a vehicle controller in communication with the first motor and the second motor; and (ii) a processing circuit of the first motor that determines only the first motor torque and applies the first motor torque at the first axle.

18. The electric vehicle of claim 15, wherein the torque signal is one of a current output torque of the drive unit and a predicted output torque of the drive unit.

19. The electric vehicle of claim 15, wherein the processor is further configured to determine the at least one of the first motor torque and the second motor torque based on at least one of: (i) a difference between the torque signal and a torque sensed at the first axle; and (ii) a difference between a torque at the first axle and a torque at the second axle.

20. The electric vehicle of claim 15, wherein the request is at least one of: (i) a speed of the electric vehicle; (ii) an acceleration of the electric vehicle; and (iii) a torque at the electric vehicle.
